(19) United States
(12) Patent Application Publication
(10) Pub. No.: US 2011/0099479 A1
(43) Pub. Date: Apr. 28, 2011

(54) INFORMATION MANAGEMENT SYSTEM AND METHOD

(75) Inventors: YANG-YUAN CHEN, Tu-Cheng (TW); MING-CHIH HSIEH, Tu-Cheng (TW)

(73) Assignee: HON HAI PRECISION INDUSTRY CO., LTD., Tu-Cheng (TW)

(21) Appl. No.: 12/818,116

(22) Filed: Jun. 17, 2010

(30) Foreign Application Priority Data
Oct. 26, 2009 (CN) 200910308802.8

(51) Int. Cl. G06F 3/01; G06F 15/16

(52) U.S. Cl. 715/736; 709/227

(57) ABSTRACT

A method for information management using a computer communicates with a plurality of electronic devices through a network. The method establishes a communication with each of the electronic devices, and installs an application sent from one of the electronic devices that is in communication with the computer. The method further scans all of the electronic devices in the network, and obtains information monitored by the electronic devices. Additionally, the method processes the obtained information, and displays the processed information on a screen of the computer through an interface of the application.

### BACKGROUND

1. Technical Field

Embodiments of the present disclosure relate to an information management system and method.

2. Description of Related Art

In traditional control systems, a computer connects with a plurality of electronic devices in series to monitor information (e.g., temperature, humidity, and harmful gas) of a particular environment. One of the electronic devices is connected with the computer directly which may be set as a master device, and the other electronic devices may be set as slave devices. The master device receives and processes the information monitored by the slave devices, and sends the processed information to the computer.

All the electronic devices connected with the computer have the same hardware design, and each of the electronic devices may be set as the master device for information processing. The more slave devices are connected with the master device in series, the more information that may be processed by the master device, which may result in the information processing and transmission delay. To solve the problem of information processing and transmission delay, it is needed to upgrade the hardware of all the electronic devices. However, this may lead to higher costs to upgrade the hardware of all the electronic devices.

Therefore, there is a need for an improved system and method to address the above-mentioned problem.

### BRIEF DESCRIPTION OF THE DRAWINGS

FIG. 1 is a block diagram of one embodiment of a computer communicates with a plurality of electronic devices through a network of an information management system.

FIG. 2 is a block diagram of one embodiment of the computer of FIG. 1 comprising a management unit.

FIG. 3 is a flowchart of one embodiment of a method for information management using the computer of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

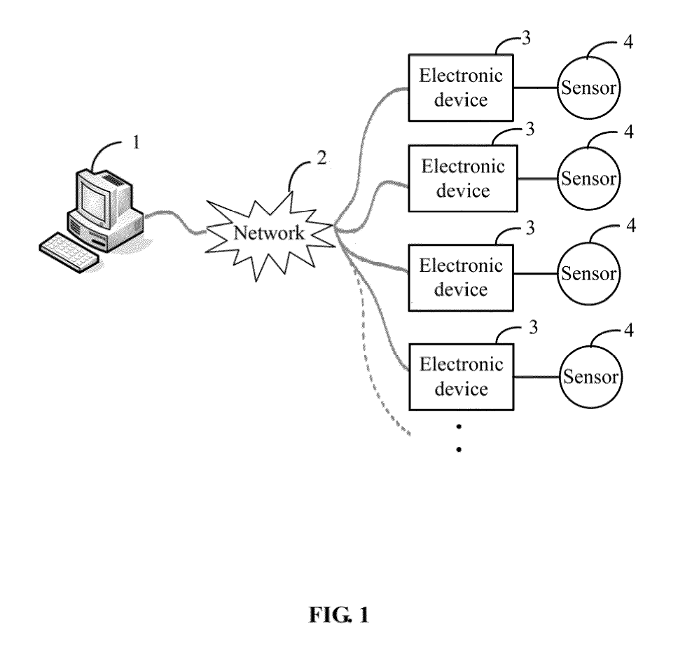

FIG. 1 is a block diagram of one embodiment of an information management system 200. The information management system 200 includes a computer 1, a network 2, a plurality of electronic devices 3, and a plurality of sensors 4. Each of the sensors 4 may be embedded in or connected with the electronic devices 3 directly. In the embodiment, the computer 1 communicates with each of the electronic devices 3 through the network 2. Each of the electronic devices 3 monitors information (e.g., temperature, humidity, and harmful gas) of a particular environment using the sensors 4. Each of the electronic devices 3 is installed with an application, which is used to scan all of the electronic devices 3 in the network 2 and collect the information monitored by the electronic devices 3. One of the electronic devices 3 sends the application to the computer 1 when a communication between the electronic device 3 and the computer 1 is established. The computer 1 manages the information monitored by the electronic devices 3. Details of managing the information are provided below.

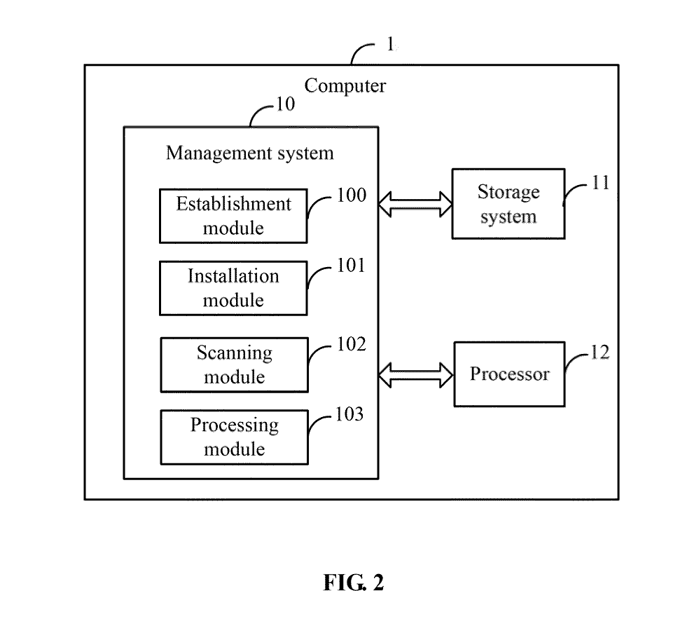

FIG. 2 is a block diagram of one embodiment of the computer 1 of FIG. 1. In the embodiment, the computer 1 may include a management unit 10, a storage system 12 and a processor 13. The management unit 10 includes an establishment module 100, an installation module 101, a scanning module 102, and a processing module 103. In general, the word “module,” as used herein, refers to logic embodied in hardware or firmware, or to a collection of software instructions, written in a programming language, such as, for example, Java, C, or Assembly. One or more software instructions in the modules may be embedded in firmware, such as EPROM. The modules described herein may be implemented as either software and/or hardware modules and may be stored in any type of computer-readable medium or other storage device.

The storage system 11 stores a plurality of programs, such as programs of an operating system, and various information received from the electronic devices 3. In one embodiment, the storage system 11 may be random access memory (RAM) for temporary storage of information, and/or a read only memory (ROM) for permanent storage of information. In other embodiments, the storage system 11 may also be an external storage device, such as a hard disk, a storage card, or a data storage medium. The processor 12 executes a plurality of computerized operations of the computer 1 and other applications, to provide functions of the computer 1.

The establishment module 100 is operable to establish a communication between the computer 1 and each of the electronic devices 3, to receive a request for information processing and the application from one of the electronic devices 3 that is in communication with the computer 1. In some embodiments, the request for information processing and the application may be sent from one of the electronic devices 3 that communicates with the computer 1 firstly.

The installation module 101 accepts the request and installs the received application on the computer 1. In some embodiments, the installation module 101 may install the application on the storage system 11 of the computer 1.

The scanning module 102 scans all of the electronic devices 3 in the network 2 using the application, to obtain the information monitored by the electronic devices 3 using the application through the network 2. The scanning module 102 also displays a total number of the electronic devices 3 that are scanned in the network 2 on a screen of the computer 1 through an interface of the application. As thus, a user can determine whether all of the electronic devices 3 are connected to the network 2 according to the total number.

The processing module 103 processes the obtained information using the application, and displays the processed information on the screen of the computer 1 through the interface of the application. In some embodiments, the processing module 103 may classify the information, sort the information, or analyze the information according to pre-determined requirements.

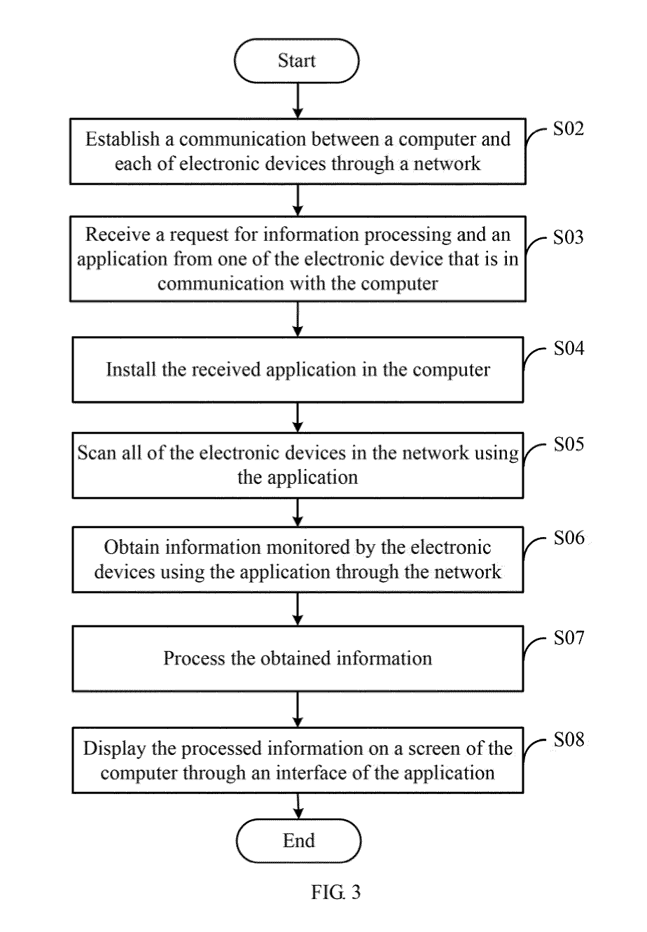

FIG. 3 is a flowchart of one embodiment of a method for information management using the computer 1 of FIG. 1. The method can manage information monitored by the electronic devices 3 distributed in the network 2, and process the information monitored by the electronic devices 3, thereby transferring a task for information processing from one of the electronic devices 3 to the computer 1. Depending on the embodiment, additional blocks may be added, others removed, and the ordering of the blocks, may be changed.

In block S02, the establishment module 100 establishes a communication with each of the electronic devices 3 through the network 2.

In block S03, the establishment module 100 receives a request for information processing and an application from one of the electronic devices 3 that is in communication with the computer 1. In some embodiments, the request for information processing and the application may be sent from one of the electronic devices 3 that communicates with the computer 1 first.

In block S04, the installation module 101 accepts the request and installs the received application on the computer 1. In some embodiments, the installation module 101 may install the application on the storage system 11 of the computer 1.

In block S05, the scanning module 102 scans all of the electronic devices 3 in the network 2 using the application, and displays a total number of the electronic devices 3 that are scanned in the network 2 on a screen of the computer 1 through an interface of the application. As thus, a user can determine whether all of the electronic devices 3 are connected to the network 2 according to the total number.

In block S06, the scanning module 102 obtains the information monitored by the electronic devices 3 using the application through the network 2.

In block S07, the processing module 103 processes the obtained information. In some embodiments, the computer 1 may classify the information, sort the information, and analyze the information.

In block S08, the processing module 103 displays the processed information on the screen of the computer 1 through the interface of the application.

As aforementioned, the information monitored by all of the electronic devices 3 is processed by the computer 1. It is not necessary to upgrade the hardware of all of the electronic devices 3 to solve the problem of information processing and transmission delay, thereby saving the costs for upgrading the hardware of the electronic devices 3.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An information management method using a computer, the method comprising:
establishing a communication between the computer and a plurality of electronic devices through a network;
receiving a request for information processing and an application from one of the electronic devices that is in communication with the computer;
accepting the request and installing the received application on the computer;
scanning all of the electronic devices in the network using the application;
obtaining information monitored by all of the electronic devices using the application through the network;
processing the obtained information; and
displaying the processed information on a screen of the computer through an interface of the application.

2. The method according to claim 1, further comprising:
displaying a total number of the electronic devices that are scanned in the network on the screen of the computer through the interface of the application.

3. The method according to claim 1, wherein the electronic devices monitor the information of an environment using sensors embedded in or connected with the electronic devices.

4. The method according to claim 4, wherein the application is predesigned according to the information of the environment.

5. A computer, comprising:
a storage system;
at least one processor; and
one or more programs stored in the storage system and being executable by the at least one processor, the one or more programs comprising:
an establishment module operable to establish a communication between the computer and a plurality electronic devices through a network, to receive a request for information processing and an application from one of the electronic devices that is in communication with the computer;
an installation module operable to accept the request and install the received application on the computer;
a scanning module operable to scan all of the electronic devices in the network using the application, to obtain the information monitored by the electronic devices through the network; and
a processing module operable to process the obtained information using the application, and display the processed information on a screen of the computer through an interface of the application.

6. The computer according to claim 5, wherein the scanning module is further operable to display a total number of the electronic devices that are scanned in the network on the screen of the computer through the interface of the application.

7. The computer according to claim 5, wherein the electronic devices monitor the information of an environment using sensors embedded in or connected with the electronic devices.

8. The computer according to claim 7, wherein the application is predesigned according to the information of the environment.

9. A medium having stored therein instructions that, when executed by a processor of a computer, causes the computer to perform an information management method, the method comprising:
establishing a communication between the computer and a plurality of electronic devices through a network;
receiving a request for information processing and an application from one of the electronic devices that is in communication with the computer;
accepting the request and installing the received application on the computer;
scanning all of the electronic devices in the network using the application;
obtaining information monitored by all of the electronic devices using the application through the network;
processing the obtained information; and
displaying the processed information on a screen of the computer through an interface of the application.

10. The medium as claimed in claim 9, the method further comprises:
displaying a total number of the electronic devices that are scanned in the network on the screen of the computer through the interface of the application.

11. The medium as claimed in claim 9, wherein the electronic devices monitor the information of an environment using sensors embedded in or connected with the electronic devices.

12. The medium as claimed in claim 11, wherein the application is predesigned according to the information of the environment.
